(19) United States
(12) Patent Application Publication
(10) Pub. No.: US 2026/0323332 A1
(43) Pub. Date: Oct. 15, 2026

(54) DOWNLINK BEAM MANAGEMENT WITH SIMULTANEOUS RECEPTION AT MULTIPLE ANTENNA PANELS

(71) Applicant: Telefonaktiebolaget LM Ericsson (publ), Stockholm (SE)

(72) Inventors: Joao VIEIRA, Hjärup (SE); Andreas NILSSON, Göteborg (SE)

(73) Assignee: Telefonaktiebolaget LM Ericsson (publ), Stockholm (SE)

(21) Appl. No.: 19/473,935

(22) PCT Filed: Apr. 11, 2023
(86) PCT No.: PCT/EP2023/059449

§ 371 Date: Oct. 9, 2025

(51) Int. Cl. H04W 24/08; H04B 7/06; H04L 5/00

(52) U.S. Cl. CPC H04W 24/08; H04B 7/06952; H04L 5/005

(57) ABSTRACT

A method (700) implemented in a wireless device (120) for facilitating a determination of at least one receive beam to be used in relation to at least one transmit receive point, TRP (115) or access point, AP, in a wireless network, the method comprising: receiving (714) from the network a downlink reference signal, DL RS, configuration indicating at least two DL RS resources to be received at different panels of the wireless device, each panel representing a group of related antennas; receiving (716) from the network a measurement trigger to perform measurements on one or more of the configured DL RS resources; performing (718) measurements on said DL RS resources using said at least two panels simultaneously; and determining (720) at least one receive beam based on the performed measurements.

### TECHNICAL FIELD

The present disclosure relates to the field of cellular communication between multiantenna transceivers. In particular, it proposes a technique for determining a beam suitable for communication from a network node to a wireless device capable of simultaneous reception at multiple antenna panels.

### BACKGROUND

In high frequency range (FR2), multiple RF beams may be used to transmit and receive signals at a base station (gNB) and a user equipment (UE). For each downlink transmit (DL Tx) beam from a gNB or a transmit receive point (TRIP) associated with the gNB, there is typically an associated best receive (Rx) beam for receiving signals from the DL beam at the UE. The DL Tx beam and the associated UE Rx beam form a beam pair. The beam pair can be identified through a so-called beam management process in NR.

Although not explicitly stated in the NR specifications, it may be considered that beam management falls into three different procedures, which are schematically illustrated in FIG. 2:
P1: Purpose is to find an approximate direction for the UE 120 using wide gNB Tx beams 211, 212, 213 from the gNB 110 covering the whole angular sector. The UE 120 can use a single Rx beam 221.
P2: Purpose is to refine the gNB Tx beam by doing a new beam search around the coarse direction found in P1, namely, by transmitting regular (narrow) Tx beams 214, 215, 216. The UE 120 can use a single Rx beam 222.
P3: Used for UEs that have analog beamforming to let them find a suitable UE Rx beam. In P3, the UE 120 receives on multiple beams 223, 224, 225 while the gNB 110 transmits on a constant beam 217, which is preferably a regular (narrow) beam. In the P3 procedure, aperiodic CSI-RSs transmitted in one narrow gNB beam may be used.

One problem with beam management procedures of the P3 type is that they take a lot of time and CSI-RS overhead to complete. This issue is expected to be aggravated for distributed MIMO (D-MIMO) and multi-TRP operation, where a UE might need to perform one P3 beam sweep for each one of multiple serving TRPs/APs. A D-MIMO system is a system with multiple geographically distributed antenna panels, possibly with respective radio and processing units, where such panels jointly coordinate aspects of their transmissions (and receptions) in order to serve the UEs. In current NR specifications, a UE cannot be scheduled with multiple P3 beam sweeps that are overlapping in time. Hence, the multiple different P3 beam sweeps required for D-MIMO and multi-TRP operation must be time-multiplexed which will increase the CSI-RS overhead and latency even more.

In addition, the UE may be equipped with multiple different UE panels, and the different UE panels may support different numbers of UE beams. A panel in this sense is a group of related transmit or receive antennas, as described in detail in the applicant's prior disclosure PCT/EP2022/076975. Moreover, each panel may support a dynamically varying number of UE beams, namely, if the beam width is configurable. In such circumstances, signaling (e.g., using the specified capability maxNumberRxBeams) only a single preferred number of CSI-RS resources for P3 beams sweeps—a number that is used regardless of the UE panel that the P3 beam sweep should be performed for—is a potentially insufficient basis for allocating CSI-RS resources, as it could add to overhead and latency. For example, the UE may be currently receiving at a panel with four beams but, in view of another panel that supports ten beams, it has reported its preferred number of CSI-RS resources to be ten.

### SUMMARY

One objective of the present disclosure is to make methods and devices available which allow a more efficient determination of at least one receive beam to be used in relation to a TRP or AP. In particular, the aimed-for methods and devices should be efficient in the sense that unnecessary allocation of reference-signal resources in the course of such determination is largely avoided. It is a further objective to ensure that the quantity of computational resources and radio resources used by these methods and devices scales favorably with respect to the number of serving TRPs/APs. It is a further objective to limit or reduce latency. A still further objective is to provide methods and devices that support wireless devices equipped with multiple antenna panels. In particular, the quantity of computational resources and radio resources used by these methods and devices should scale favorably with respect to the number of panels on the wireless device.

At least some of these objectives are achieved by the invention as defined in the independent claims. The dependent claims are directed to advantageous embodiments.

In a first aspect of the present disclosure, there is provided a method for facilitating a determination of at least one receive beam to be used in relation to at least one transmit receive point (TRP) or access point (AP) in a wireless network. The method is implemented in a wireless device and comprises: receiving from the network a downlink reference signal (DL RS) configuration indicating at least two DL RS resources to be received at different panels of the wireless device, each panel representing a group of related antennas; receiving from the network a measurement trigger to perform measurements on one or more of the configured DL RS resources; performing measurements on said DL RS resources using said at least two panels simultaneously; and determining at least one receive beam based on the performed measurements.

By the method according to the first aspect, because measurements are performed on multiple panels simultaneously, a given number of receive beams can be swept in shorter time. This tends to limit or reduce latencies in the wireless network.

In a second aspect of the disclosure, there is provided a method for facilitating a determination of at least one receive beam to be used by a wireless device in relation to at least one TRP or AP in a wireless network. The method is implemented in a network node of the wireless network and comprises: transmitting to the wireless device a DL RS configuration indicating at least two DL RS resources to be received at different panels of the wireless device, each panel representing a group of related antennas; transmitting to the wireless device a measurement trigger for the wireless device to perform measurements on one or more of the configured DL RS resources; and transmitting on said DL RS resources for thereby enabling the wireless device to perform measurements using said at least two panels.

A network node executing the method according to the second aspect leverages the ability of some connected wireless devices to receive at multiple panels simultaneously. This reduces the time spent on sweeping candidate receive beams, and could in some circumstances liberate radio resources (DL RS resources) on a system level.

There is further provided, according to a third and fourth aspect of the present disclosure, a wireless device and a network node that operate in accordance with the above-described methods. In general terms, the wireless device and the network node share the effects and advantages of these methods, and they can be implemented with a corresponding degree of technical variation.

This disclosure will further describe a computer program containing instructions for causing a computer, or the wireless device or network node in particular, to carry out the above methods. The computer program may be stored or distributed on a data carrier. As used herein, a “data carrier” may be a transitory data carrier, such as modulated electromagnetic or optical waves, or a non-transitory data carrier. Non-transitory data carriers include volatile and non-volatile memories, such as permanent and non-permanent storage media of magnetic, optical or solid-state type. Still within the scope of “data carrier”, such memories may be fixedly mounted or portable.

In some embodiments, there is provided a special beam sweep capability, a data structure through which a wireless device can indicate its ability to perform two, three or more simultaneous beam sweeps at different panels. This allows the network to adapt the DL RS configuration to each connected wireless device. Optionally, the DL RS configuration is generated on the basis of the obtained special beam sweep capability. In further developments, the special beam sweep capability is a data structure that indicates the beams supported by the wireless device, as well as characteristics of these beams. The special beam sweep capability may further include information relating to the panels of the wireless device.

In some embodiments, the wireless device defines at least one association (e.g., a one-to-one association) between a panel and a respective TRP/AP, and indicates this to the network node to guide the allocation of DL RS resources.

In some embodiments, the measurement trigger includes an indication of a beam type to be used for receiving the DL RS resources. Because the number of beams supported by the wireless device may be different for different beam types, the indication of the beam type to be used helps the network node allocate the DL RS resources with greater accuracy, notably with respect to their total number.

In some embodiments, some of the DL RS resources in the DL RS resource set can dropped in specific circumstances. Depending on whether the network can predict the dropping or not, the dropping can manifest itself in that the wireless device omits a measurement, or in that the network node omits a transmission, or in both of these. For example, if the special beam sweep capability indicates a number of supported beams for a panel and a beam type which number is less than the number of DL RS resources in the DL RS resource set, some of these DL RS resources may be dropped at the transmitting or the receiving end, or both. This economizes the signaling overhead devoted to the DL RS configuration, since the network may content itself with a coarse partly redundant configuration and leave the fine tuning (or trimming) to the dropping rule.

For the purposes of the present disclosure, a “beam” may be defined by an DL RS resource. More precisely, the network may transmit on a set of DL RS resources, wherein each DL RS resource is transmitted on a separate beam. The network may then schedule the UE on one of said beams by referring to one of the transmitted DL RS resources, e.g., in terms of DL RS indices, which are in a one-to-one relationship with the corresponding beams.

In the present disclosure, further, the terms user equipment (UE) and wireless device are used interchangeably.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order described, unless explicitly stated.

### BRIEF DESCRIPTION OF THE DRAWINGS

Aspects and embodiments are now described, by way of example, with reference to the accompanying drawings, on which:

FIG. 1 shows a wireless device in the coverage area of one single-TRP base station and one multi-TRP base station;

FIG. 2 illustrates three example beam management procedures;

FIG. 3 illustrates uplink beam management;

FIG. 4 is a perspective view of a UE with four panels;

FIG. 5 is a schematic drawing of a UE with three panels oriented in orthogonal directions to improve coverage, wherein the UE has one baseband chain at its disposal that can be connected to one of the panels at a time;

FIG. 6 depicts an example use case of the present disclosure, namely, a communication setup including a UE with four panels which operates in a multi-TRP/D-MIMO mmWave deployment;

FIG. 7 is a sequence diagram illustrating a method of determining a Rx beam to be used for communication between a network node and a UE; and

FIGS. 8 to 10 show example switching networks for a UE with four panels, where up to two panels can be used for simultaneous transmission.

### DETAILED DESCRIPTION

The aspects of the present disclosure will now be described more fully hereinafter with reference to the accompanying drawings, on which certain embodiments of the invention are shown. These aspects may, however, be embodied in many different forms and should not be construed as limiting; rather, these embodiments are provided by way of example so that this disclosure will be thorough and complete, and to fully convey the scope of all aspects of the invention to those skilled in the art. Like numbers refer to like elements throughout the description.

### D-MIMO Operation

A distributed MIMO (D-MIMO) system is a wireless communication system with multiple geographically distributed antenna panels, possibly with respective radio and processing units, where such panels jointly coordinate aspects of their transmissions (and receptions) in order to serve one or more UEs. One type of D-MIMO deployments is in terms of coordinating macro-gNBs, as considered in the 3GPP Release-18 MIMO Work Item “MIMO Evolution for Downlink and Uplink” (RP-213598). Another type of D-MIMO deployments, widely considered as a candidate for 6G D-MIMO, includes dense localized deployments where several small-sized low-powered panels/nodes are densely deployed in a specific part of the cell requiring a capacity/reliability enhancement. Such deployments are expected to be useful, for example, in crowded parts of a macro-cell area, such as public squares or stadiums.

In the context of macro deployments, the D-MIMO panels and respective radio and processing units are termed transmit receive points (TRPs). In the context of dense localized deployments, the D-MIMO panels—and respective radio and processing units—are oftentimes referred to as access points (APs). The terms TRP and AP will be used interchangeably in this disclosure.

There exist different levels of coordination between TRPs which allow for different D-MIMO transmission modes. These levels of coordination correspond to
non-coherent joint transmission, e.g. where the same or different layers can be transmitted from different TRPs without per-TRP precoding accounting for the instantaneous (amplitude and) phase of the DL channel; and
coherent joint transmission (CJT), where the same layer(s) is sent from different TRPs, and precoded per-TRP, such that the signals associated with the different TRP layer transmissions add-up constructively at the spatial location where the intended UE is.

While it is expected to use the highbands (frequency bands in an upper portion of the spectrum) in D-MIMO systems with the aim of improving coverage, reliability, and mobility, the midbands (frequency bands in a central portion of the spectrum) may be utilized to improve the spectral efficiency. Non-coherent joint transmission schemes are the major type of transmission schemes considered for the highbands, since the inter-TRP phase calibration needed for CJTs is more challenging to perform at higher frequencies; this is due, on the one hand, to the relatively tighter link budget at higher frequencies, but also to the more significant phase noise, which could make CJT infeasible.

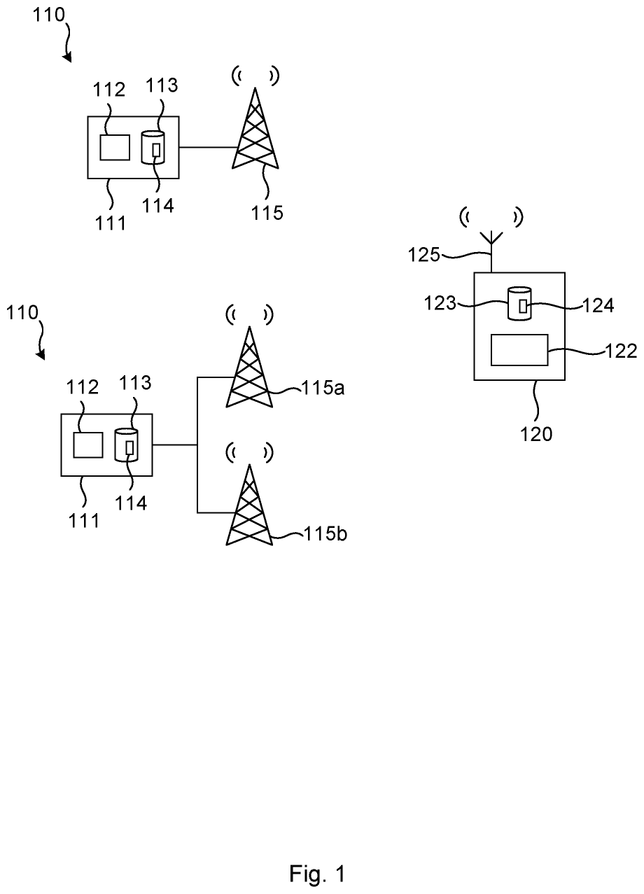

FIG. 1 relates to a first deployment where a wireless device 120 is located in the coverage area of one base station 110 with a single TRP 115 (upper portion of FIG. 1), and one base station 110 with two TRPs 115a, 115b (lower portion of FIG. 1). The base stations 110 are configured as network nodes in a radio access network within a cellular telecommunication system, such as a 3GPP NR system.

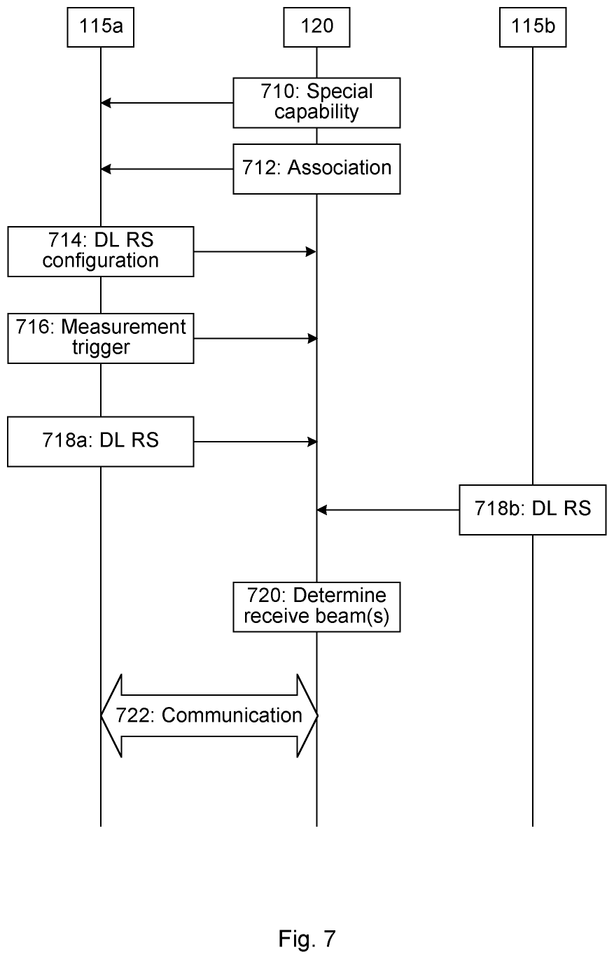

The figure schematically illustrates, in terms of a number of functional units, the components of the wireless device 120 according to an embodiment. Processing circuitry 122 is provided using any combination of one or more of a suitable central processing unit (CPU), multiprocessor, microcontroller, digital signal processor (DSP), etc., capable of executing software instructions stored in a computer program product 124, e.g. in the form of a storage medium 123. The processing circuitry 122 may further be provided as at least one application specific integrated circuit (ASIC), or field programmable gate array (FPGA). Particularly, the processing circuitry 122 is configured to cause the wireless device 120 to perform a set of operations, or steps, as disclosed below with reference to FIG. 7. For example, the storage medium 123 may store the set of operations, and the processing circuitry 122 may be configured to retrieve the set of operations from the storage medium 123 to cause the wireless device 120 to perform the set of operations. The set of operations may be provided as a set of executable instructions. Thus the processing circuitry 122 is arranged to execute the method for facilitating the determination of a beam to be used when the wireless device 120 communicates with the network node 110, to be described with reference to FIG. 7. The storage medium 123 may also comprise persistent storage, which, for example, can be any single one or combination of magnetic memory, optical memory, solid state memory or even remotely mounted memory.

The wireless device 120 may further comprise a communications interface 125 for communications with the network nodes 110. As such, the communications interface 125 may comprise one or more transmitters and receivers, comprising analog and digital components. The processing circuitry 122 controls the general operation of the wireless device 120, e.g. by sending data and control signals to the communications interface 125 and the storage medium 123, by receiving data and reports from the communications interface 125, and by retrieving data and instructions from the storage medium 123. Other components, as well as the related functionality, of the wireless device 120 are omitted in order not to obscure the concepts presented herein.

FIG. 1 further illustrates, in terms of a number of functional units, the components of the network nodes 110 according to an embodiment. Each network node 110 comprises a frontend unit 111 and at least one TRP 115. The frontend unit 111 may be co-located with the TRP 115 or located remotely from this. In the frontend unit 111, processing circuitry 112 is provided using any combination of one or more of a suitable CPU, multiprocessor, microcontroller, DSP, etc., capable of executing software instructions stored in a computer program product 114, e.g. in the form of a storage medium 113. The processing circuitry 112 may further be provided as at least one ASIC or FPGA. Particularly, the processing circuitry 112 is configured to cause each network node 110 to perform a set of operations, or steps, as disclosed below with reference to FIG. 7. For example, the storage medium 113 may store the set of operations, and the processing circuitry 112 may be configured to retrieve the set of operations from the storage medium 113 to cause the wireless device 110 to perform the set of operations. The set of operations may be provided as a set of executable instructions. Thus the processing circuitry 112 is arranged to execute the method for determining a beam to be used when the network node 110 communicates with the wireless device 120, to be described with reference to FIG. 7. The storage medium 113 may also comprise persistent storage, as exemplified above.

The network node 110 may further comprise a communications interface, including the TRP 115, for communications with the wireless device 120. As such, the communications interface may comprise one or more transmitters and receivers, comprising analogue and digital components. The processing circuitry 112 controls the general operation of the network node 110, e.g. by sending data and control signals to the communications interface (with the TRP 115) and the storage medium 113, by receiving data and reports from the communications interface, and by retrieving data and instructions from the storage medium 113. Other components, as well as the related functionality, of the network nodes 110 are omitted in order not to obscure the concepts presented herein.

### Beam Management Procedure

As noted initially, multiple RF beams may be used to transmit and receive signals at a gNB and a UE in the FR2 frequency range. For each DL Tx beam from a gNB, there is typically an associated best UE Rx beam for receiving signals from the DL beam. The two associated beams form a beam pair, which can be identified through a so-called beam management process in NR.

A widely practiced way of identifying a DL beam is by transmitting an associated DL RS in the beam, either periodically, semi-persistently or aperiodically. In the context of the 3GPP NR radio interface, the DL RS for the purpose can be a Synchronization Signal (SS) and Physical Broadcast Channel (PBCH) block (SSB) or a Channel State Information RS (CSI-RS). In future 6G implementations, equivalent RSs may be defined, possibly with a different distribution of the purposes synchronization and beam management over the different RS types. By measuring all the DL RSs, the UE can determine and report to the gNB the best DL beam to use for DL transmissions. The gNB can then transmit a burst of DL-RS in the reported best DL beam to let the UE evaluate candidate UE Rx beams.

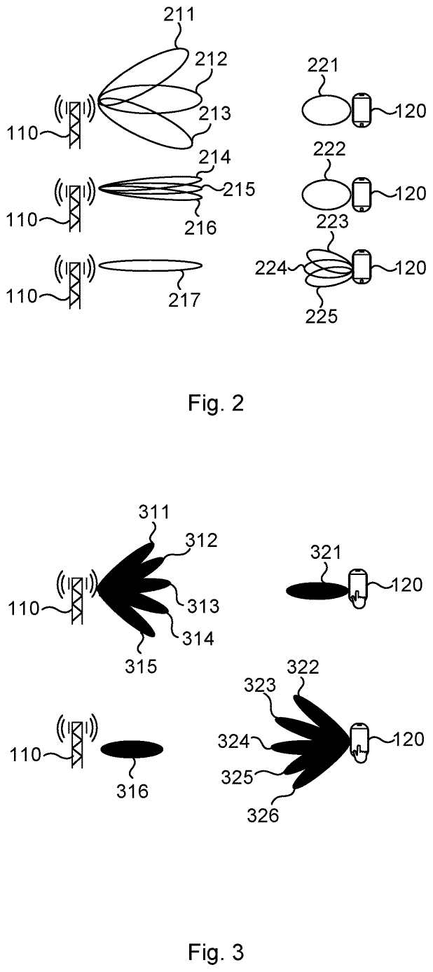

As also noted above, the main procedures for beam management can be identified:
P1: Purpose is to find an approximate direction for the UE 120 (FIG. 2) using wide gNB Tx beams 211, 212, 213 from the gNB 110 covering the whole angular sector. The UE 120 can use a single Rx beam 221.
P2: Purpose is to refine the gNB Tx beam by doing a new beam search around the coarse direction found in P1, namely, by transmitting regular (narrow) Tx beams 214, 215, 216. The UE 120 can use a single Rx beam 222.
P3: Used for UEs that have analog beamforming to let them find a suitable UE Rx beam. In P3, the UE 120 receives on multiple beams 223, 224, 225 while the gNB 110 transmits on a constant beam 217, which is preferably a regular (narrow) beam.

In these procedures, P1 is expected to utilize beams with rather large beamwidths and where the beam reference signals are transmitted periodically and are shared between all UEs of the cell. Typically reference signal to use for P1 are periodic CSI-RS or SSB. The UE then reports the N best beams to the gNB and their corresponding RSRP values. P2 is expected to use aperiodic/or semi-persistent CSI-RS transmitted in narrow beams 214, 215, 216 around the coarse direction found in P1. P3 finally is expected to use aperiodic or semi-persistent CSI-RSs repeatedly transmitted in one narrow gNB beam 217. One alternative way is to let the UE determine a suitable UE Rx beam based on the periodic SSB transmission. Since each SSB consists of four OFDM symbols, a maximum of four UE Rx beams 223, 224, 225 can be evaluated during each SSB burst transmission. One benefit with using SSB instead of CSI-RS is that no extra overhead of CSI-RS transmission is needed.

It is remarked that the just outlined beam management procedures may require some adaptation in order to be useful in the uplink. More precisely, some UEs might have analog beamformers without beam correspondence or with poor beam correspondence (i.e. Tx/Rx correspondence), which implies that DL/UL reciprocity cannot always be used to determine the beams for these beamformers. For such UEs, the UE beam used for UL cannot be derived from beam management procedures based on DL reference signals as described above. To handle such UEs, UL beam management has been included in the NR standard specification since release 15. The main difference between normal beam management and UL beam management is that UL beam management utilizes uplink reference signals instead of DL reference signals. The UL reference signals that have been agreed to be used for UL beam management in 3GPP NR is sounding reference signals (SRS).

FIG. 3 schematically illustrates the two UL beam management procedures that are supported in NR: U2 and U3. The U2 procedure (upper half) is performed by the UE 120 transmitting a burst of SRS resources in one UE Tx beam 321 and letting the gNB's TRP 115 evaluate different TRP Rx beams 311, 312, 313, 314, 315. The U3 procedure (lower half) lets the UE find a suitable UE Tx beam by transmitting different SRS resources in different UE Tx beams 322, 323, 324, 325, 326 while the TRP 110 maintains a constant beam 316.

### UE Analog Beamforming Architecture

For UEs, the signals can arrive and emanate from all different directions, which makes it is beneficial to have an antenna implementation at the UE which has the possibility to generate omni-directional-like coverage in addition to the high gain narrow beams. One way to increase the omni-directional coverage at a UE is to install multiple panels, and point (orient) these panels into different directions, which typically is the case for commercial UEs. However, in order to reduce the cost and energy consumption, some of these UEs can only transmit from one UE panel—or possibly two UE panels—at each point in time.

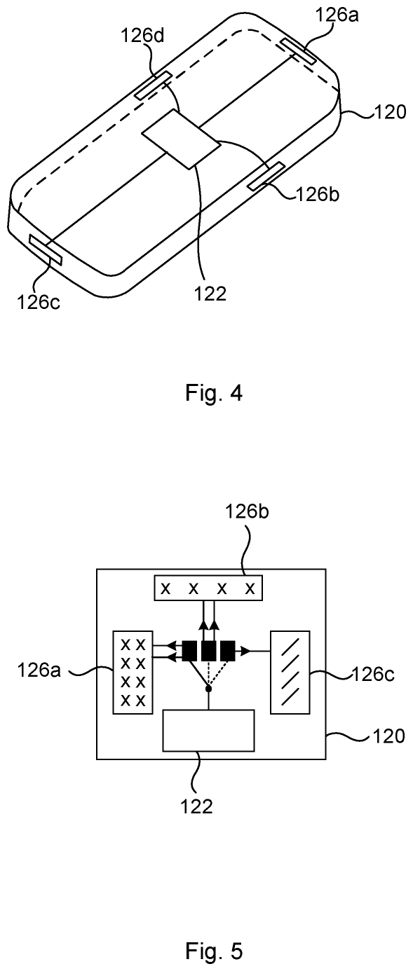

FIG. 4 illustrates one example of a realistic UE 120 with two baseband chains (one per polarization) 122 which are used to switch between four different dual-polarized panels 126. Each panel 126 is operable to transmit beams in directions typically corresponding to a half plane into the main transmit direction of the panel. More precisely, the antennas in one panel 126 may be oriented parallel to each other into a common direction. Oftentimes though not necessarily, the antennas in one panel 126 are physically close, e.g., the mutual distances of the antennas in one panel 126 are smaller than the distance to an antenna in any other panel. Further, the antennas in one panel 126 may be fed with an RF signal at a common input point, which can be connected and disconnected to the baseband chain 122 collectively.

FIG. 5 shows a wireless device 120 with three panels 126 oriented in orthogonal directions to improve spherical coverage. The wireless device has two baseband chains 122 at its disposal that can be connected to one of the panels 126 at a time. This ability is illustrated by an analog switch in FIG. 5. Further, the panels 126 differ from each other with respect to maximum number of TX/RX chains, and number of antenna elements. In the drawing, the slash-like symbol inside a panel 126 refers to an antenna element with a first polarization, and the backslash-like symbol refers to an antenna element with a second polarization different from the first polarization.

With reference to a similar UE structure, it is described in the presentation
Qualcomm Technologies, Breaking the Wireless Barriers to Mobilize 5G NR mmWave, May 2019, downloaded from https://www.qualcomm.com/content/dam/qcomm-martech/dm-assets/documents/breaking_the_wireless_barriers_to_mobilize_5g_nr_mmwave.pdf
   how antenna switching can be used to switch between three UE panel modules M1, M2, M3.

A UE panel of a commercial UE can generate beams of different beam widths, as exemplified by Table 1.

TABLE 1

| Beamforming | Half-power beam | Equivalent isotropically | Number of pointing |
|---|---|---|---|
| gain | width (HPBW) | radiated power (EIRP) | directions |
| 0 dB | 90 degrees | 13 dBm | 1 beam |
| 3 dB | 90 degrees | 19 dBm | 5 beams |
| 9 dB | 30 degrees | 25 dBm | 9 beams |

A widely practiced solution in commercial UEs is to generate the wider beams by temporarily deactivating one or more power amplifiers (PAs) of the panel. This evidently has a negative impact on the available output power. However, it is possible to mitigate the output-power loss when generating wide beams by applying dual-polarized beamforming, e.g., using array-size-invariant (ASI) beamforming. It is useful for the UE to generate a wide beam of a panel during beam sweep procedures to first find a coarse direction to a serving AP/TRP, which would enable the UE to select and activate a suitable UE panel. In the example of Table 1, the UE can generate one wide beam, five semi-wide (or half-wide) beams, and nine narrow beams for each panel.

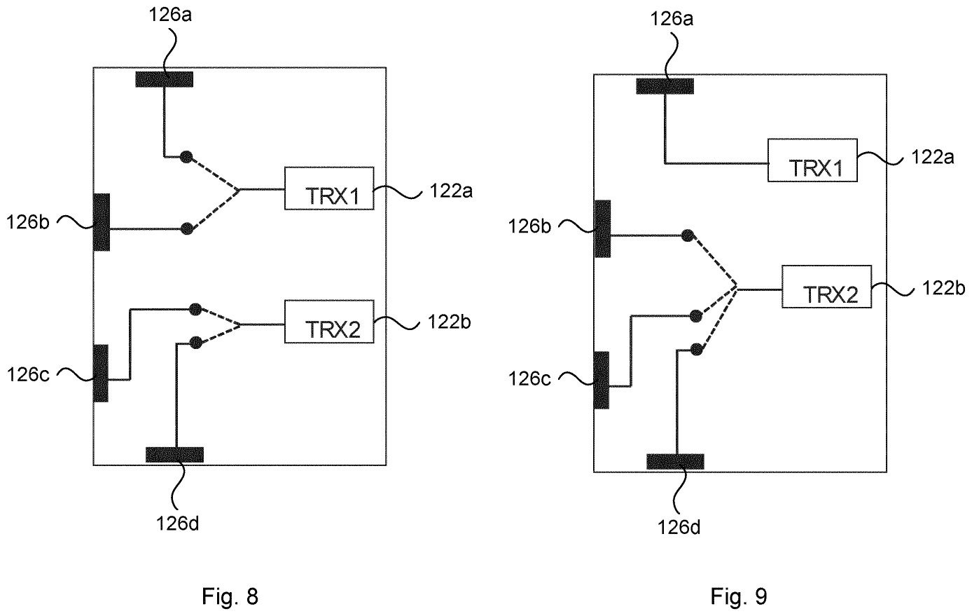

Because different UEs may have panel-switching networks with different layouts, the UEs differ with respect to the UE panels/beams that can be used for simultaneous transmission or simultaneous reception. FIGS. 8, 9 and 10 schematically depict three examples that illustrate this variation between UEs.

In FIG. 8, the two upper UE panels 126a, 126b cannot be used for simultaneous DL/UL transmission/reception because they share the upper transceiver chain 122a. Similarly, the two lower UE panels 126c, 126d cannot be used for simultaneous DL/UL transmission/reception because they share the lower transceiver chain 122b. An exhaustive list of all pairs of simultaneously transmitting/receiving panels is thus: {126a, 126c}, {126b, 126c}, {126a, 126d} and {126b, 126d}. All other UE panel combinations are excluded. The panel-switching network in FIG. 8 may be characterized as a balanced panel-switching network.

In FIG. 9, the upper UE panel 126a has the upper transceiver chain 122a to itself. The three lower UE panels 126b, 126c, 126d however cannot be used for simultaneous DL/UL transmission/reception because they share the lower transceiver chain 122b. Considering the unequal association of panels to transceiver chains, the panel-switching network in FIG. 9 may be characterized as an unbalanced panel-switching network.

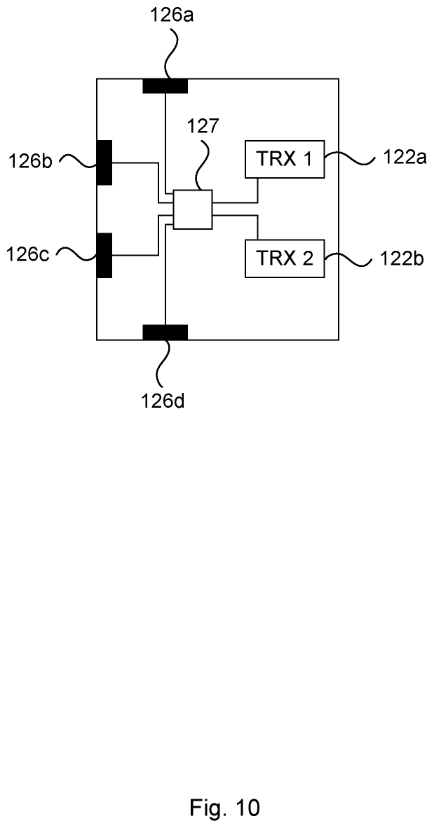

In FIG. 10, finally, there is illustrated a panel-switching network with a central universal switch 127, which is operable to connect any one UE panel 126 to any one transceiver chain 122. The panel-switching network in FIG. 10 may thus be characterized as a fully flexible panel-switching network.

### UE Capability Reporting for P3 Beam Sweep

In current releases of 3GPP NR, a UE can signal support for P3 beam management procedures (i.e., UE beam sweep based on DL-RS) by indicating the capability maxNumberRxBeam or maxNumberRxBeam-v1720 during UE capability signaling. These capabilities are specified as follows:
“Defines whether UE supports receive beamforming switching using NZP CSI-RS resource. UE shall indicate a single value for the preferred number of NZP CSI-RS resource repetitions per CSI-RS resource set. Support of Rx beam switching is mandatory for FR2.”

As part of these capabilities, the UE can indicate its preferred number of CSI-RS resources to be used during the P3 procedure, which could be taken as an indication of the number of narrow beams the UE supports for one of its panels. However, only a single value can be reported, which means there is no possibility to indicate different numbers of supported beams for different UE panels, nor different numbers of beams for different beam widths.

### Downlink Beam Management Method

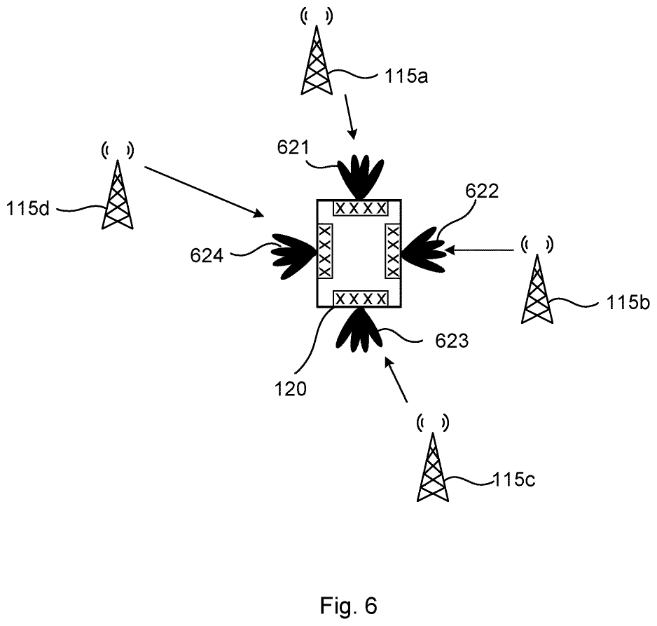

FIG. 6 depicts an example use case of the present disclosure, in which a UE 120 with four panels operates in a multi-TRP/D-MIMO mmWave deployment. More precisely, a UE 120 with four panels is located in an intersection of coverage areas of the TRPs 115a, 115b, 115c, 115d. The wireless device 120 is configured for operation in the mmWave (or sub-terahertz) band, or more generally in any frequency band where analog beamforming is used. Each panel is operable to receive beams 621, 622, 623, 624 in directions typically corresponding to a half plane into the main direction of each panel. Specifically, different UE panels are associated with different TRPs/APs 115 in the sense that a specific UE panel is best situated for receiving from that TRP/AP and/or the UE 120 has indicated such an association (without specifying reasons) to the network.

The present disclosure addresses, among others, the stage when the network has already as determined suitable TRP/APs and/or at least one suitable beam per TRP/AP for the UE, for example by relying on some degree of channel reciprocity when processing transmitted UL signals/channels, or based on a TRP/AP beam report (e.g. associated a previously performed P1 or P2 procedure). After this, the next step is to determine suitable UE beams for respective identified serving TRP/AP. Please note that even if the UE can only simultaneously receive on a subset of its available panels—the cardinality of this subset may be smaller than the number of TRPs—the UE could still be helped by determining beam pair links with respect to all candidate TRPs/APs. This is because the reliability of the communication between network and UE is more improved the more TRPs are used. Indeed, current NR specifications include time division multiplexing (TDM) repetitions schemes over two different TRP for all DL and UL channels, which have shown to improve reliability compared to single TRP repetition due to improved spatial diversity.

Reference is made to FIG. 7, which is a sequence diagram illustrating a method of determining one or more receive beams to be used for communication between a wireless device 120 (or UE) and at least one network node 110 (e.g., a TRP or an AP) in a wireless network. From the wireless device's 120 point of view, FIG. 7 provides a method for facilitating the determination of one or more receive beams to be used by the wireless device 120 for communication with the network node 110. From the network node's 110 perspective, FIG. 7 provides a method for determining one or more receive beams to be used by the wireless device 120 for communication with the wireless device 120; additionally, the network node 110 may determine one or more beams for its own use in said communication. Preferably, the wireless device 120 is a wireless device which is capable of at least partially analog beamforming, including various forms of constrained digital beamforming, such as time-domain digital beamforming or frequency-domain digital beamforming.

In an optional first step 710, the wireless device 120 indicates a special beam sweep capability referring to an indicated number of simultaneous beam sweeps, wherein the indicated number of DL RS resources are received at different panels. The indicated special beam sweep capability is indicated to the network and becomes available to the network node 110 directly or indirectly. The method 700 may be performed without the step 710, for example, if an applicable standard specifies that each compliant wireless device 120 shall support at least a number N of simultaneous beam sweeps, wherein N may for example be 2, 3, 4 or higher.

In some embodiments, the “Special beam sweep capability” (which may carry a different name) includes one or more of the following:
1. a supported number of simultaneous P3-type beam sweeps, wherein each P3-type beam sweep is for determining a receive beam to be used by the wireless device 120;
2. a number of panels 126 of the wireless device 120;
3. a number of panels that are capable of simultaneous reception, or identifiers of (e.g., index values) those panels 126;
4. a characteristic of a panel-switching network of the wireless device, such as balanced panel-switching network, unbalanced panel-switching network and/or fully flexible panel-switching network;
5. a number of supported beam types per panel, each beam type associated with a different beam width;
6. an approximate beam width of a supported beam type;
7 a number of supported beams for a supported beam type;
8. a number of supported beams for a panel;
9. a number of supported beams for a supported beam type and a panel;
10. a number of supported narrow beams for a panel;
11. a number of available receive chains for a panel;
12. groups of panel identifiers, where each identifier is associated with one or more reported aspects (e.g. number of preferred/supported beams for one panel), such that panels in the same reported group cannot simultaneously perform a P3 beam sweep.

With reference to item 4, it is recalled that example beam-switching networks with different characteristics have been described with reference to FIGS. 8, 9 and 10.

With reference to items 7-10, the number of supported beams of a given type refers to a number of unique beams of that type that the wireless device 120 wishes to evaluate. The wireless device 120 may indicate, in the special beam sweep capability, as many beams of that type that it is capable of, or fewer beams. Formulated differently, the number of supported beams in the special beam sweep capability need not be a technically exhaustive description of the wireless device's 120 hardware or software, but rather refers to the number of beams the wireless device 120 wants to have evaluated with the assistance of the network. The number of supported beams indicated in the special beam sweep capability may be understood as a preferred number of beams.

With reference to item 12, an example use is that the wireless device 120 may report the two groups {1,2} and {3,4} for the beam-switching network of FIG. 8, the two groups {1} and {2,3,4} for FIG. 9, and the four trivial groups {1}, {2}, {3} and {4} for FIG. 10. The panel identifier may be a logical identifier maintained by the wireless device 120.

In an optional second step 712, which may form part of the method 700 together with step 710 or on its own, the wireless device 120 indicates to the network, for at least one of the wireless device's 120 panels 126, an association between that panel and a TRP/AP 115. The association can be used as the wireless device 120 sees fit, e.g., to indicate that a certain panel 126 currently has an advantageous orientation relative to the TRP/AP 115. Further, according to some embodiments, it may be understood that if the wireless device 120 indicates two such associations, between a first panel 126 and a first TRP/AP 115 and between a second panel 126 and a second TRP/AP 115, then the wireless device 120 shall support simultaneous beam sweeps on the first and second panels 126, i.e., the DL RS resources to be received on these first and second panels 126 can be partially overlapping in time.

It is understood that step 712 is typically performed in advance. For example, the indication 712 of the association between the panel 126 and the TRP/AP 115 is made in a different beam management procedure than the measurements (see step 718 below) to be made on said DL RS resources. For example, the association between the panel 126 and the TRP/AP 115 can be included in a beam report relating to a P1-type or P2-type beam management procedure. The measurements 718 can be performed within a P3-type beam management procedure. A further option is to that the indication 712 and the measurements 718 belong to two instantiations of the same type of beam management procedure.

The method 700 includes a step 714, where the network node 110 transmits—and the wireless device 120 receives—a DL RS configuration indicating at least two DL RS resources to be received at different panels 126 of the wireless device 120. The DL RS configuration may be conveyed using semistatic signaling, such as RRC signaling. As described above, each panel 126 may represent a group of related antennas. The DL RS configuration may indicate a number of DL RS resources which form a single group of several groups. The DL RS resources may correspond to Channel State Information RS (CSI-RS) resources. In some embodiments, the DL RS resources may form a number of DL RS resource sets. The fact that a group of DL RS resources belong to a particular DL RS resource set may be recognizable from the fact that they contain an equally valued DL RS resource set index and/or from their position in a data structure that represents the DL RS configuration.

In a next step 716 of the method 700, the network node 110 transmits—and the wireless device 120 receives—a measurement trigger for the wireless device 120 to perform measurements on one or more of the configured DL RS resources. The measurement trigger can be conveyed in Downlink Control Information (DCI), in a MAC-layer control element (MAC-CE), by RRC signaling, or by another suitable signaling vehicle. Optionally, the measurement trigger includes an indication of a beam type to be used for receiving the DL RS resources. The beam type is preferably a beam type selected from a plurality of beam types with different beam widths, e.g., by indicating an index of that beam type from a pre-agreed list. The indication of the beam type may be in part implicit, e.g. there may be a pre-agreed rule that the absence of a beam-type data element in the measurement trigger indicates that the wireless device 120 shall receive a default beam type.

Subsequently, in a step 718, the network node 110 transmits on said DL RS resources (or, formulated closer to certain language in 3GPP TS 38.214, the network node 110 transmits said DL RS resources), wherein the wireless device 120 is expected to perform measurements using said at least two panels 126. The measurements on the panels 126 may be simultaneous or overlap partially in time. The network node's 110 transmission on the DL RS resources may be carried out, at the request of the network node 110, by one or more TRPs 115a, 115b or APs. In particular, the network node 110 may transmit the DL RS resources using at least one TRP/AP that was not used for transmitting the DL RS configuration and measurement trigger. The measurements may be CSI-RS measurements in accordance with a 3GPP NR specification or in accordance with a 6G specification.

In a next step 720, on the basis of the measurements in step 718, the wireless device 120 may select a most suitable receive beam or receive beams. The wireless device 120 may select one or more receive beams from a first panel 126 and one or more receive beams from a second panel 126. The receive beam may be identified by the DL RS resource, normally the one on which the DL RS was received by the wireless device 120 with highest signal energy or highest signal to interference and noise ratio (SINR).

The selected beams are then used the network node 110 and wireless device 120, in a step 722, for communication by downlink transmissions of data and signaling. Step 722 may include simultaneous downlink reception and/or simultaneous uplink transmission at multiple UE panels 126.

In a first group of embodiments of the method 700, the DL RS resources are grouped into a number of DL RS resource sets and each DL RS resource set is associated with a different panel 126 of the wireless device 120. In particular, the DL RS resource configuration may include two or more DL RS resource sets. The association may be indicated by including, in the DL RS configuration, a panel identifier for each DL RS resource set.

Within the first group of embodiments, the special beam sweep capability may indicate a number of supported beams for a panel which is associated with a DL RS resource set. Then, the DL RS resource set may have as many DL RS resources as said number of supported beams. Specifically, the special beam sweep capability may indicate a number of supported beams of a given type (e.g., with a certain width) and the DL RS set may have as many resources as the number of supported beams of the given type.

Within the first group of embodiments, alternatively or additionally, the DL RS configuration may include at least a first and a second DL RS resource set, which are respectively associated with a first and a second panel 126 of the wireless device, and different beams 621, 622, 623, 624 of the respective panel 126 are to be used for measurements on different DL RS resources within each DL RS resource set. An optional additional feature is that the special beam sweep capability indicates whether the first and second panels are capable of simultaneous reception, and the network node 110 allocates DL RS resources on this basis. In particular, if the special beam sweep capability indicates that the first and second panels are capable of simultaneous reception, the first and second DL RS resource sets are at least partly overlapping in time. Otherwise, if the special beam sweep capability does not indicate that the first and second panels are capable of simultaneous reception, then the first and second DL RS resource sets are disjoint in time.

Within the first group of embodiments, alternatively or additionally, the DL RS configuration may include at least a first and a second DL RS resource set, which are respectively associated with a first and a second panel 126 of the wireless device 120 and which include different numbers of DL RS resources, and the measurement trigger includes an indication of a first beam type to be used for receiving the DL RS resources in the first DL RS resource set and a second beam type to be used for receiving the DL RS resources in the second DL RS resource set. In this situation, the network node 110 may be expected to select the first and the second beam types such that they have different beam widths- and thus a different number of supported unique beams-which contributes to efficient usage of the available DL RS resources in the system.

Within the first group of embodiments, alternatively or additionally, the DL RS configuration may include at least a first and a second DL RS resource set, which are associated with the same panel 126 of the wireless device 120. Then, the measurement trigger includes an indication of a first beam type to be used for receiving the DL RS resources in the first DL RS resource set and an independent indication of a second beam type to be used for receiving the DL RS resources in the second DL RS resource set. An optional further development is for the special beam sweep capability to indicate a respective number of supported beams for the first and second beam types; then, each DL RS resource set may include a number of DL RS resources which is equal to the respective number of supported beams.

A second group of embodiments of the method 700 target a situation where the DL RS configuration includes a DL RS resource set which is associated with a panel 126 of the wireless device 120, the measurement trigger includes an indication of a beam type to be used for receiving the DL RS resources in the DL RS resource set, and the special beam sweep capability indicates a number of supported beams for said panel 126 and beam type. In this situation, when said number of supported beams is less than the number of DL RS resources in the DL RS resource set, at least one of the DL RS resources is dropped. Dropping a DL RS resource may imply that the wireless device 120 omits a measurement on the dropped DL RS resource. Dropping a DL RS resource may imply, further, that the network node 110 omits a transmission (which optionally may be carried out by a TRP/AP associated with the network node 110) on the dropped DL RS resource. Omitting a transmission on a DL RS resource may correspond to transmitting with at most 10% of a nominal transmit energy, preferably transmitting with zero energy (with transmit circuitry active), and more preferably forgoing transmission. The dropping of the DL RS resource may manifest itself in the wireless device 120 and, optionally, in the network node 110 as well; this is to say, the network node 110 may not always be aware of the fact that the wireless device 120 is going to omit a measurement. The selection of the DL RS resource to be dropped and the effects of the dropping may follow a dropping rule, or implicit dropping rule, which depends on a characteristic (e.g., the supported number of beams) of the wireless device 120. The dropping rule may be pre-agreed for the wireless network and the devices which are served by it, or the dropping rule may be pre-agreed between the network node 110 and the wireless device 120.

In an embodiment within the second group, the DL RS resource set includes NR DL RS resources, and the special beam sweep capability indicates N_{B} beams for said panel and beam type, in which case a number N_{R}-N_{B} of DL RS resources in the DL RS resource set shall be dropped. The beam type indicated in the measurement trigger may be a type which can be characterized as semi-wide relative to the width of other beams that the panel 126 supports.

In this embodiment, it may be derivable based on the dropping rule which ones of the DL RS resources in the DL RS resource set are to be dropped. For example, the dropped N_{R}-N_{B} DL RS resources may be first in time or last in time in the DL RS resource set. Alternatively, if the DL RS resources are associated with respective DL RS resource indices, the dropped N_{R}-N_{B} DL RS resources have the lowest or the highest DL RS resource indices in the DL RS resource set.

In a third group of embodiments of the method 700, the DL RS resource configuration includes as many DL RS resource sets as the wireless device's supported number of simultaneous P3-type beam sweeps. The transmissions 718 on the DL RS sets can then be overlapping in time. In particular, the transmissions 718 may be simultaneous, and even resource-by-resource synchronous in the DL RS sets. The wireless device's supported number of simultaneous P3-type beam sweeps can be equal to a standardized UE capability (or minimum requirement), or it may be indicated under item 1 of the special beam sweep capability.

In one embodiment within the third group, all DL RS resource sets in the DL RS resource configuration have an equal number of DL RS resources. If additionally the special beam sweep capability includes a respective number of supported beams for a panel associated with one of the DL RS resource sets (items 7-10 above) and the DL RS resource set includes more DL RS resources than said number of supported beams for the panel, then at least one of the DL RS resources is dropped. This embodiment allows the DL RS configuration to be conveyed to the wireless device 120 while consuming less signaling resources; more precisely, the network node 110 can content itself with configuring a first DL RS resource set for a first panel 126 explicitly and configuring the remaining DL RS resource sets—for the remaining panels—by (implicit) reference to the first DL RS resource set, knowing that the wireless device 120 will drop excess DL RS resources for certain DL RS sets. The network node 110 may even predict which DL RS resources will be dropped by the wireless device 120, and allocate these resource to other devices in the wireless network.

In a different embodiment within the third group, the special beam sweep capability includes, for a plurality of panels 126 of the wireless device 120, a respective number of supported beams. Then, each DL RS resource set in the DL RS resource configuration is associated with a panel 126 and its number of DL RS resources is equal to said respective number of supported beams. In other words, because the cardinality of the DL RS resource sets is adapted to the capability of each UE panel 126, there no need to drop DL RS resources.

In a fourth group of embodiments of the method 700, the DL RS resources are grouped into a number of DL RS resource sets and each DL RS resource set is associated with a beam type to be used. For example, the DL RS configuration may specify that a DL RS resource set S1 comprises DL RS resource 1, DL RS resource 2 and DL RS resource 3, and that beam type A is to be used for all resources in DL RS resource set S1. This represents an alternative to including the indication of the beam type in the measurement trigger.

In some embodiments of the method 700, a DL RS resource set includes NR DL RS resources, the DL RS resource set is associated with a panel 126 of the wireless device 120, and the special beam sweep capability indicates N_{B} beams for a beam type to be used and for the panel 126 associated with the DL RS resource set. Then, the number of DL RS resources in the DL RS resource set to be dropped is N_{R}-N_{B}.

In some embodiments, the method 700 comprises an uplink (UL) request transmitted by the wireless device 120 between the DL RS configuration (step 714) and the measurement trigger (step 716). The UL request may be useful in a situation where the wireless device 120 realizes that a previously selected beam for one of its panels 126 will not yield an adequate performance, e.g., its associated RSRP is below a threshold. The wireless device 120 may react to this realization by sending said UL request for a P3 procedure for that particular panel 126, which is covered by the DL RS configuration already transmitted (step 714). The UL request asking for the P3 beam sweep can be sent in the form of a certain PRACH, or a control message over a pre-scheduled PUCCH resource. Once the network node 110 receives the UL request, it can send the measurement trigger to the wireless device 120 (corresponding to step 716), in which the network node 110 indicates the subset of the configured DL RS resources that are associated with the panel 126 to which the UL request related, and measurements can begin.

The aspects of the present disclosure have mainly been described above with reference to a few embodiments. However, as is readily appreciated by a person skilled in the art, other embodiments than the ones disclosed above are equally possible within the scope of the invention, as defined by the appended patent claims.

1-37. (canceled)

38. A method implemented in a wireless device for facilitating a determination of at least one receive beam to be used in relation to at least one transmit receive point (TRP) or access point (AP) in a wireless network, the method comprising:
receiving from the network a downlink reference signal (DL RS) configuration indicating at least two DL RS resources to be received at different panels of the wireless device, each panel representing a group of related antennas;
receiving from the network a measurement trigger to perform measurements on one or more of the configured DL RS resources;
performing measurements on said DL RS resources using said at least two panels simultaneously; and
determining at least one receive beam based on the performed measurements.

39. The method of claim 38, wherein
the method further comprises indicating to the network a special beam sweep capability referring to an indicated number of simultaneous beam sweeps, wherein the indicated number of DL RS resources are received at different panels.

40. The method of claim 39, wherein
the special beam sweep capability comprises:
a supported number of simultaneous P3-type beam sweeps, wherein each P3-type beam sweep is for determining a receive beam to be used by the wireless device;
a number of panels of the wireless device;
a number of, or identifiers of, those panels that are capable of simultaneous reception;
a characteristic of a panel-switching network of the wireless device, such as balanced panel-switching network, unbalanced panel-switching network and/or fully flexible panel-switching network;
a number of supported beam types per panel, each beam type associated with a different beam width;
an approximate beam width of a supported beam type;
a number of supported beams for a supported beam type;
a number of supported beams for a panel;
a number of supported beams for a supported beam type and a panel;
a number of supported narrow beams for a panel;
a number of available receive chains for a panel; and/or
groups of panel identifiers such that panels in the same reported group cannot simultaneously perform a beam sweep groups of panel indexes.

41. The method of claim 38, wherein
the method further comprises indicating to the network an association between a panel and a TRP/AP.

42. The method of claim 41, wherein
the indication of said association between the panel and the TRP/AP and the measurements on said DL RS resources belong to two different beam management procedures or two different instances of a beam management procedure.

43. The method of claim 41, wherein
the DL RS configuration is grouped into DL RS resource sets, each DL RS resource set being associated with a different panel.

44. The method of claim 43, wherein
the special beam sweep capability indicates a number of supported beams for a panel which is associated with a DL RS resource set, and
the DL RS resource set has as many DL RS resources as said number of supported beams.

45. The method of claim 43, wherein
the DL RS configuration includes at least a first and a second DL RS resource set, which are respectively associated with a first and a second panel of the wireless device; and
different beams of the respective panel are to be used for measurements on different DL RS resources within each DL RS resource set.

46. The method of claim 41, wherein
the measurement trigger includes an indication of a beam type to be used for receiving the DL RS resources, wherein optionally the beam type is selected from a plurality of beam types with different beam widths.

47. The method of claim 46, wherein
the DL RS configuration includes at least a first and a second DL RS resource set, which are respectively associated with a first and a second panel of the wireless device and which include different numbers of DL RS resources,
the measurement trigger includes an indication of a first beam type to be used for receiving the DL RS resources in the first DL RS resource set and a second beam type to be used for receiving the DL RS resources in the second DL RS resource set, and
the first and the second beam types have different beam widths.

48. The method of claim 46, wherein
the DL RS configuration includes at least a first and a second DL RS resource set, which are associated with the same panel of the wireless device, and
the measurement trigger includes an indication of a first beam type to be used for receiving the DL RS resources in the first DL RS resource set and an independent indication of a second beam type to be used for receiving the DL RS resources in the second DL RS resource set.

49. The method of claim 48, wherein:
the special beam sweep capability indicates a respective number of supported beams for the first and second beam types, and
each DL RS resource set includes a number of DL RS resources equal to the respective number of supported beams.

50. The method of claim 38, wherein
the DL RS resource configuration includes as many DL RS resource sets as the wireless device's supported number of simultaneous P3-type beam sweeps.

51. The method of claim 38, wherein
the DL RS configuration is grouped into DL RS resource sets and includes an indication of a beam type to be used for receiving the DL RS resources in at least one of the DL RS resource sets.

52. A non-transitory computer readable storage medium storing a computer program comprising instructions which, when run on processing circuitry of a network node, cause the network node to perform the method of claim 38.

53. A method implemented in a network node of a wireless network for facilitating a determination of at least one receive beam to be used by a wireless device in relation to at least one transmit receive point, TRP or access point, AP, in the wireless network, the method comprising:
transmitting to the wireless device a downlink reference signal (DL RS) configuration indicating at least two DL RS resources to be received at different panels of the wireless device, each panel representing a group of related antennas;
transmitting to the wireless device a measurement trigger for the wireless device to perform measurements on one or more of the configured DL RS resources; and
transmitting on said DL RS resources for thereby enabling the wireless device to perform measurements using said at least two panels.

54. The method of claim 53, wherein
the method further comprises obtaining from the wireless device an indication of a special beam sweep capability referring to an indicated number of simultaneous beam sweeps, wherein the indicated number of DL RS resources received at different panels of the wireless device.

55. The method of claim 53, wherein
the method further comprises obtaining an indication of an association between a panel of the wireless device and a TRP/AP.

56. A wireless device for facilitating a determination of at least one receive beam to be used in relation to at least one transmit receive point (TRP) or access point (AP) in a wireless network, the wireless device comprising:
a plurality of panels, each panel representing a group of related antennas; and
processing circuitry, wherein the wireless device is operable to perform a method comprising:
receiving from the network a downlink reference signal (DL RS) configuration indicating at least two DL RS resources to be received at different panels of the wireless device;
receiving from the network a measurement trigger to perform measurements on one or more of the configured DL RS resources;
performing measurements on said DL RS resources using said at least two panels simultaneously; and
determining at least one receive beam based on the performed measurements.

57. A network node of a wireless network for facilitating a determination of at least one receive beam to be used by a wireless device in relation to at least one transmit receive point (TRP) or access point (AP) in the wireless network, the network node comprising:
a transmitter; and
processing circuitry, wherein the network node is operable to perform a method comprising:
transmitting to the wireless device a downlink reference signal (DL RS) configuration indicating at least two DL RS resources to be received at different panels of the wireless device, each panel representing a group of related antennas;
transmitting to the wireless device a measurement trigger for the wireless device to perform measurements on one or more of the configured DL RS resources; and
transmitting on said DL RS resources for thereby enabling the wireless device to perform measurements using said at least two panels.
